(19) United States
(12) Patent Application Publication
(10) Pub. No.: US 2017/0369190 A1
(43) Pub. Date: Dec. 28, 2017

(54) PERFORMANCE PREDICTION METHODS AND SYSTEMS FOR MAINTENANCE OF AIRCRAFT FLIGHT CONTROL SURFACE COMPONENTS

(71) Applicant: The Boeing Company, Chicago, IL (US)

(72) Inventors: James M. Ethington, St. Charles, MO (US); Liessman Sturlaugson, Chesterfield, MO (US)

(21) Appl. No.: 15/192,758

(22) Filed: Jun. 24, 2016

(51) Int. Cl. B64F 5/60; B64C 9/00; G07C 5/08

(52) U.S. Cl. CPC B64F 5/60; G07C 5/0816; G07C 5/0841; B64C 9/00; G07C 5/0833; G07C 5/0825

(57) ABSTRACT

Predictive aircraft maintenance methods include extracting feature data from flight data collected during a flight of the aircraft, calculating a performance classifier indicator that indicates a performance category of the selected flight control surface component within a threshold number of future flights based on the feature data, and determining the performance status of the selected flight control surface component relative to the threshold number of future flights based on the performance classifier indicator. Such methods may include classifying the feature data with an ensemble of related primary classifiers to produce a primary classifier indicator for each primary classifier and aggregating the primary classifier indicators to produce the performance classifier indicator indicating the performance category of the selected active component for the threshold number of future flights.

Predictive aircraft maintenance systems may include modules configured to extract feature data, classify feature data, and aggregate classifications.

### FIELD

The present disclosure relates to performance prediction methods and systems for maintenance of aircraft flight control surface components.

### BACKGROUND

Aircraft and other complex apparatuses include a myriad of interoperating components. Many subsystems of components are designed for maintenance and/or repair. When such a subsystem or component performs unexpectedly (e.g., it becomes non-responsive or functions with degraded performance), the operation of the aircraft may be impacted and the aircraft may be subject to unscheduled maintenance and down time. As an example, servomechanisms operating flight control surfaces of aircraft may become non-operational and may consequently result in strain on the flight control system, fuel waste, aircraft down time, excess troubleshooting, strain on the replacement part supply, and/or potential stress on other aircraft components and systems. The consequences of an unexpected need to repair or an unexpected repair of the non-performing component may be much greater than the cost, in time and resources, to repair or replace the non-performing component.

For many components, operators currently have no insight into the health of the components. Moreover, subsystems and components may behave erratically and unexpectedly well before complete non-performance. The behavior of components that may lead to non-performance may manifest as merely non-specific system degradation and related effects.

Aircraft may be available for maintenance and diagnosis only between flights. If a component performs unexpectedly during a flight, the non-performing component may require an abrupt end to the flight, necessitating a return trip for repair or at least temporary abandonment of the aircraft.

If a component does not pass pre-flight tests, the component may need to be repaired or replaced before the next flight. After a component has performed unexpectedly during a flight and resulted in noticeable system performance degradation, maintenance staff may troubleshoot the aircraft function and eventually identify the non-performing part as a contributor to the observed system performance degradation. The unscheduled down time and maintenance to identify the issue and to repair or replace the non-performing component may lead to resource conflicts with the aircraft. The aircraft typically is unavailable for use during troubleshooting and repair. Additionally, the unscheduled down time and maintenance may lead to strains on the scheduling of maintenance personnel due to excess time troubleshooting and identifying the issue, and may lead to strains on the supply chain for replacement parts because the need for parts may not be predictable. This reactive response to non-performing components may be inefficient when compared to scheduled maintenance or a proactive response to impending component non-performance.

### SUMMARY

Predictive aircraft maintenance systems and methods are disclosed. Predictive maintenance methods include methods of determining a performance status of a selected active component (such as a flight control surface component) in an aircraft by extracting feature data from flight data collected during a flight of the aircraft, calculating a performance classifier indicator that indicates a performance category of the selected active component within a threshold number of future flights based on the feature data, and determining the performance status of the selected active component relative to the threshold number of future flights based on the performance classifier indicator. Such methods may include classifying the feature data with an ensemble of related primary classifiers to produce a primary classifier indicator for each primary classifier and aggregating the primary classifier indicators to produce the performance classifier indicator that indicates the performance category of the selected active component for the threshold number of future flights. The primary classifiers are each configured to indicate a primary category of the selected active component within a given number of flights. The given number of flights for each primary classifier is different. The threshold number of future flights is less than or equal to the maximum of the given numbers of the primary classifiers.

Predictive maintenance systems include systems for determining a performance category of a selected active component in an aircraft. Systems may include a feature extraction module and a performance classification module. The feature extraction module is configured to extract feature data from flight data collected during a flight of the aircraft. The performance classification module is configured to produce a performance classifier indicator that indicates a performance category of the selected active component within the threshold number of future flights based on the feature data. The performance classification module may include a primary classification module and an aggregation module. The primary classification module is configured to produce a primary classifier indicator for each primary classifier of an ensemble of related primary classifiers, each primary classifier being configured to indicate a primary category of the selected active component within a given number of future flights based on the feature data. The given numbers of the primary classifiers are different from each other. The aggregation module is configured to produce the performance classifier indicator that indicates the performance category of the selected active component for a threshold number of future flights based on the primary classifier indicators of the primary classifiers. The threshold number of future flights is less than or equal to the maximum of the given numbers of the primary classifiers.

### BRIEF DESCRIPTION OF THE DRAWINGS

FIG. 1 is a schematic representation of an aircraft and associated predictive maintenance system.

FIG. 2 is a schematic representation of an aircraft with subsystems of the aircraft.

FIG. 3 is a schematic illustration of an example of an aircraft indicating flight control surfaces.

FIG. 4 is a schematic representation of a flight control system of an aircraft.

FIG. 5 is a schematic representation of a predictive maintenance system.

FIG. 6 is a schematic representation of predictive maintenance methods.

FIG. 7 is a schematic representation of a computerized system.

### DESCRIPTION

Conventional approaches to detecting a non-performing component typically include a test to determine whether the subject component is functional (e.g., a built-in test system as typically found in aircraft). Additionally or alternatively, the performance of a component may be monitored as it is actuated. If the test indicates the component is performing unexpectedly, the operator (e.g., aircrew) and/or service personnel are notified of the need for repair or replacement. Generally, this type of testing provides only present, and possibly past, indications of component performance and no indication of future performance, such as impending non-performance. However, the operational characteristics of the component may indicate future behavior and/or the potential for future non-performance. Hence, the operational characteristics of the component may be utilized to reliably schedule component maintenance prior to any unexpected performance. As used herein, non-performing and non-performance include unexpected performance, degraded performance, and/or non-responsiveness. Non-performing and non-performance may include partial operation (e.g., when a component performs expectedly in some situations but not others, or when a component provides a functional but inadequate response) and complete non-operation (e.g., when a component does not respond to commands or other input, or when a component provides an unacceptable response).

By accurately predicting future component performance (i.e., when to expect non-performance events), repair and/or replacement of the component may be scheduled with other maintenance and/or inspections (reducing potential downtime), flights (for example) may be flown normally (without compromised subsystems and without compromised performance), and demand for replacement parts may be predicted with some reliability. The accurate prediction of component performance also may avoid unexpected performance of the subject component and sympathetic performance responses from related components or subsystems (e.g., due to the added stress of a non-performing component in a complicated subsystem).

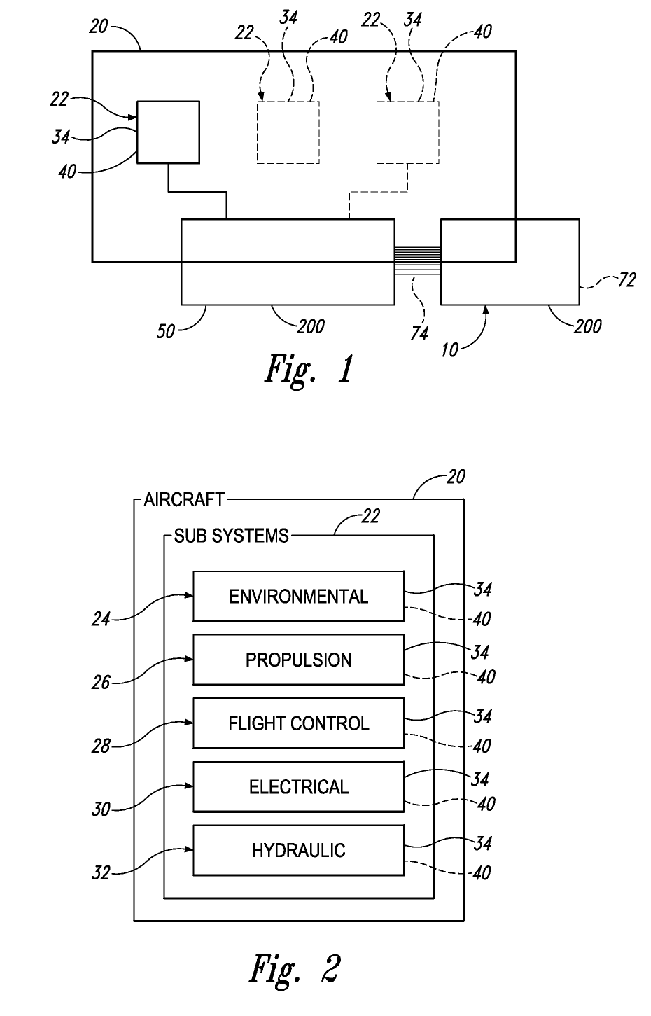

FIGS. 1-7 illustrate various aspects of predictive maintenance systems and methods according to the present disclosure. In general, in the drawings, elements that are likely to be included in a given embodiment are illustrated in solid lines, while elements that are optional or alternatives are illustrated in dashed lines. However, elements that are illustrated in solid lines are not essential to all embodiments of the present disclosure, and an element shown in solid lines may be omitted from a particular embodiment without departing from the scope of the present disclosure. Elements that serve a similar, or at least substantially similar, purpose are labeled with numbers consistent among the figures. Like numbers in each of the figures, and the corresponding elements, may not be discussed in detail herein with reference to each of the figures. Similarly, all elements may not be labeled or shown in each of the figures, but reference numerals associated therewith may be used for consistency. Elements, components, and/or features that are discussed with reference to one or more of the figures may be included in and/or used with any of the figures without departing from the scope of the present disclosure.

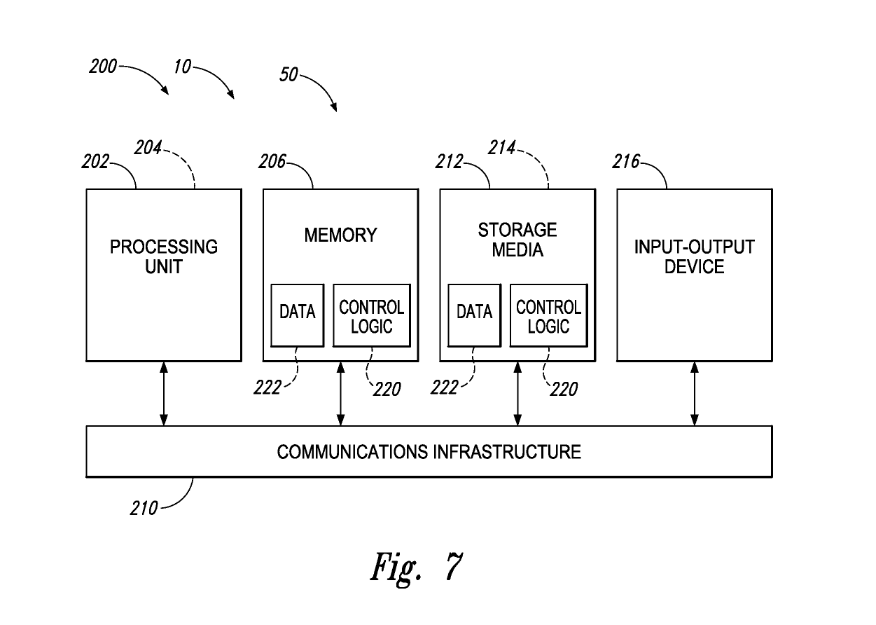

As illustrated in FIG. 1, a predictive maintenance system 10 includes a computerized system 200 (as further discussed with respect to FIG. 7). The predictive maintenance system 10 may be programmed to perform, and/or may store instructions to perform, the methods described herein.

The predictive maintenance system 10 is associated with an aircraft 20. The predictive maintenance system 10 may be an independent system and/or may be a part of the aircraft 20 (an on-board system, also referred to as an on-platform system), as schematically represented by the overlapping boxes of aircraft 20 and predictive maintenance system 10 in FIG. 1. In particular, where the predictive maintenance system 10 is physically independent of the aircraft 20, the predictive maintenance system 10 may be associated with a plurality of aircraft 20 (e.g., a fleet of aircraft 20).

Aircraft 20 are vehicles configured for flight and include one or more subsystems 22 that control, perform, and/or monitor one or more aspects of aircraft operation. As indicated in FIG. 2, examples of subsystems 22, which also may be referred to as systems, include an environmental control system 24, a propulsion system 26, a flight control system 28, an electrical system 30, and a hydraulic system 32. Subsystems 22 may be a portion of other systems or subsystems of aircraft 20. For example, subsystem 22 may be a rudder control system that is a subsystem of the flight control system 28. Subsystems 22 include one or more active components 34 used to perform the function of the subsystem 22. Examples of active components 34 include an actuator, a servomechanism, an engine, a motor, an electronics module, and a pump. Active components 34 may be referred to as parts, elements, modules, units, etc., and may be line replaceable and/or field replaceable (e.g., line replaceable units). Active components 34 may be subsystems of the respective subsystem 22. Active components 34 are active and/or controlled components, i.e., active components 34 are configured to change state during flight of the aircraft 20. Active components 34 may be electrical, optical, mechanical, hydraulic, fluidic, pneumatic, and/or aerodynamic components.

If an active component 34 performs unexpectedly, or otherwise is non-performing, the operation of the corresponding subsystem 22 may be impacted. Many aircraft 20 are designed to be tolerant of component non-performance. For example, aircraft 20 may include redundant subsystems 22 and/or subsystems 22 may incorporate redundant active components 34. Additionally or alternatively, subsystems 22 may be designed to safely operate with less than all active components 34 fully functional, e.g., by operating with reduced performance.

As shown generally in FIGS. 1 and 2, subsystems 22 generally include sensors 40 configured to measure and/or monitor the performance of individual active components 34, groups of active components 34, and/or the subsystem 22. Additionally or alternatively, sensors 40 may measure and/or monitor the environmental condition, the condition of one or more active components 34, and/or the inputs and/or outputs of the subsystem 22 and/or the active component(s) 34. Sensors 40 may be utilized in built-in testing, performance monitoring, and/or subsystem control. Sensors 40 may be and/or may include encoders, accelerometers, position sensors, electronic compasses, strain gauges, temperature sensors, and/or pressure transducers.

Further, aircraft 20 may include a controller 50 that may be configured to control and/or monitor one or more subsystems 22, active components 34, and/or sensors 40. Controller 50 may be on board the aircraft 20 (also referred to as on-platform), may be operated independent of the aircraft 20, and may be a system independent of the aircraft 20 (also referred to as off-platform), as schematically represented by the overlapping boxes of aircraft 20 and controller 50 in FIG. 1. Controller 50 and predictive maintenance system 10 may communicate via a data link 74. The data link 74 is an electronic communication link and may include one or more wired, wireless, radio, optical, and/or electrical communication channels.

The predictive maintenance system 10 may include a display module 72 that is configured to present visual, audio, and/or tactile signals to an operator and/or user of the predictive maintenance system 10. The signals may be configured to indicate system information, for example, indicating the identity of the selected active component 34, a performance status and/or performance category (e.g., operational, good, degraded performance, non-performing, impending non-performance, and/or maintenance needed), that the selected active component 34 is likely to non-perform (or likely to perform), and/or the predicted remaining useful life of the selected active component 34 (e.g., the number of flights before predicted non-performance). As further described with respect to FIG. 7, predictive maintenance system 10 and/or controller 50 may include, and/or may be, a computerized system 200.

If one of the active components 34 of the flight control system 28 performs unexpectedly (e.g., by moving inconsistently or incompletely when commanded), the overall flight control system 28 may continue to operate. For example, other flight control surfaces 36 with performing active components 34 may be used in lieu of the flight control surface 36 with the non-performing active component 34 and/or the flight control system 28 may operate at reduced performance (e.g., with limited maneuverability). Because the flight control system 28 may be critical to operate at full performance, even less than complete non-performance of an active component 34 may need to be addressed immediately, potentially leading to aborted flights and/or unscheduled maintenance of the aircraft 20. Once a non-performing active component 34 has been identified, the non-performing active component 34 generally is repaired as soon as possible, e.g., before the next flight. An urgent repair may strain the supply chain for replacement parts and/or an unscheduled repair and downtime may lead to a lower availability of the aircraft 20 and/or the lack of availability of the aircraft 20 at critical moments in time.

Where it is hard to predict when an active component 34 may perform unexpectedly, the urgency to repair a non-performing active component may be heightened (e.g., to avoid having a subsystem 22 with more than one non-performing active component). Further, unexpected performance of some active components 34 may stress the respective subsystem 22 and may contribute to and/or cause other active components 34 to perform unexpectedly. Hence, the non-performing active component 34 typically is immediately repaired when non-performance is identified. The urgent repair may result in aborted flights and/or unscheduled maintenance of the aircraft, with the consequent unscheduled downtime, and may strain the supply chain for replacement parts. Unscheduled repair and downtime may lead to a lower availability of the aircraft 20 and/or the lack of availability of the aircraft 20 at critical moments in time.

Though examples may refer to flight control systems 28 and/or to aircraft 20, the systems and methods of this disclosure may be utilized with other subsystems 22 and other apparatuses. For example, the subsystem 22 may be a hydraulic system 32 and the active component 34 may be an electronic switch, a valve, or a pump. Further, systems and methods of the present disclosure may be applied to other vehicles and/or machinery. Hence, a reference to aircraft 20 may be replaced with a reference to a vehicle and/or machinery. Corresponding terms like flight may be replaced by terms like excursion and/or operation; flying may be replaced by driving, operating, and/or running.

As used herein, the term ‘fleet’ refers to one or more of the subject aircraft, vehicles, and/or machinery. A fleet may refer to all of the subject aircraft, vehicles and/or machinery at a location, based at a location, used for a similar purpose, and/or used by a corporate entity (e.g., a corporation, a military unit). For a fleet of aircraft, each aircraft 20 may be substantially identical with the same types of subsystems 22 and the same types of active components 34 in the subsystems 22. As used herein, active components 34 of the same type are active components 34 in equivalent locations, serving equivalent functions in the different aircraft 20 and/or subsystems 22.

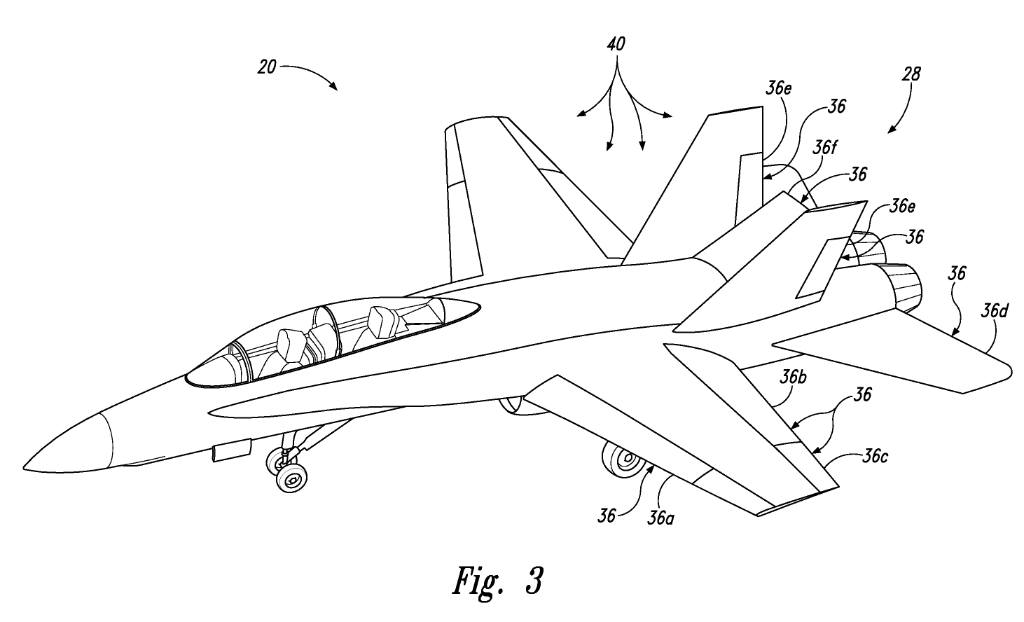

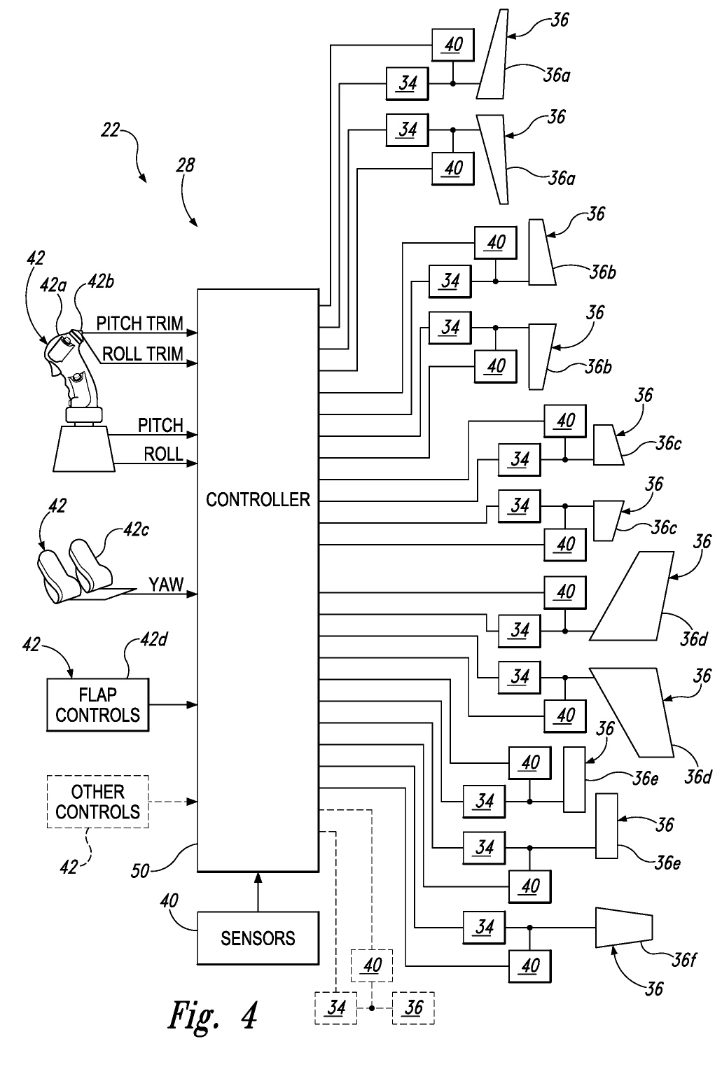

To illustrate the discussion of subsystems 22 and active components 34 in a particular example, FIGS. 3 and 4 illustrate an aircraft 20 and components of the flight control system 28. The flight control system 28 includes flight control surfaces 36 and associated active components 34 and sensors 40. In FIGS. 3 and 4, examples of flight control surfaces 36 include leading edge flaps 36a, trailing edge flaps 36b, ailerons 36c, stabilators 36d, rudders 36e, and speed brake 36f. Other examples of flight control surfaces 36 include flaps, slats, tabs, elevators, and spoilers. Active components 34 that control a flight control surface 36 (also referred to as flight control surface components) generally include a servomechanism and/or an actuator to control the positions of the associated flight control surfaces 36.

Generally, sensors 40 and/or controllers 50 are configured to collect data during flight of the aircraft 20. The data collected are referred to as flight data. Data may include records of environmental conditions (e.g., temperature, pressure, humidity), aircraft operation (e.g., airspeed, altitude, ground location, heading), flight performance (e.g., acceleration (in a direction and/or about an axis), vertical acceleration, velocity (in a direction and/or about an axis), vertical velocity, pitch rate, roll rate, yaw rate, angle of attack, attitude, etc.), subsystem operation (actual operation), subsystem command status (expected operation), component operation (actual operation), and/or component command status (expected operation). Controller 50 may be configured to store flight data and may be referred to as a flight data storage system.

Generally, active components 34 are part of a feedback loop in which a control signal from the controller 50 commands the active component 34 to react (e.g., move to a position) and in which one or more sensors 40 generate a response signal that indicates the result of the command (e.g., a position achieved in response to the command to move). The controller 50 may process the response signal to generate a new (or modified) control signal to reduce the error between the intent of the command and the result of the command. Active components 34 may be a part of an open or closed control loop.

Active components 34 may be controlled based on static or dynamic set points, user inputs, and/or the state of other active components 34, the subsystem 22 that includes the active component 34, other subsystems 22, and/or the aircraft 20 (e.g., flight performance parameters such as acceleration (in a direction and/or about an axis), vertical acceleration, velocity (in a direction and/or about an axis), vertical velocity, pitch rate, roll rate, yaw rate, angle of attack, attitude, etc.).

FIG. 4 illustrates the controller 50 of a flight control system 28 configured to control flight control surfaces 36 via active components 34, sensors 40, and control inputs 42, optionally in one or more feedback loops. Control inputs 42 are configured to accept operator (e.g., aircrew) inputs and to provide the operator inputs to the controller 50 (as control input values). Control inputs 42 may be configured to accept operator inputs for one or more active components 34. Examples of control inputs 42 illustrated in FIG. 4 are a control stick 42a (also called a yoke), a trim switch 42b, rudder pedals 42c, and a flap control switch 42d. Control inputs 42 provide control input values that may indicate a position, a force, a pressure, and/or an angle. For example, control input values may be a control stick position (e.g., a lateral position, longitudinal position), a rudder pedal position, a rudder pedal differential position (a difference in positions between two rudder pedals), an engine throttle setting (e.g., an engine throttle lever position), a switch position (e.g., on or off), a control stick rotation (an angular position), and/or a knob position (an angular position).

Feedback loops, where present, may incorporate feedback and control signals from one or more control inputs 42, one or more sensors 40, and/or settings of one or more other feedback loops. A feedback loop for one active component 34 generally incorporates signals from its associated control input 42 and sensor 40. The feedback loop may incorporate signals from control inputs 42 for other active components 34, sensors 40 associated with other active components 34, and/or other sensors 40 (supplied directly or indirectly through other controllers 50 or flight computers).

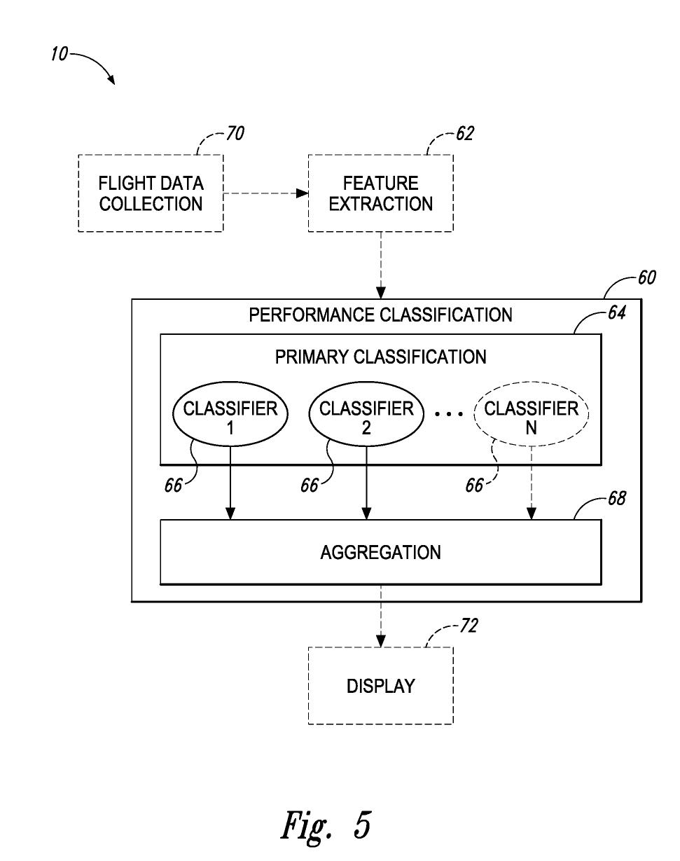

FIG. 5 is a schematic representation of a predictive maintenance system 10. The predictive maintenance system 10 is configured to utilize flight data and/or feature data extracted from flight data to identify categories to which the feature data belong with respect to an active component 34 (e.g., to estimate the likelihood of non-performance and/or performance of the active component 34 during a future flight of the aircraft 20). Categories also may be referred to as predictions and/or estimates of performance of the active component 34 during future flights (e.g., estimates of the likelihood of non-performance also may be referred to as predictions of future non-performance). The flight data and/or extracted feature data may relate to the active component 34 directly or may relate to the associated subsystem 22 and/or aircraft 20. The active component 34 that is the subject of the predictive maintenance system 10 may be referred to as the subject active component 34 and/or the selected active component 34.

The predictive maintenance system 10 may be part of a health management system and/or a health assessment system for the associated aircraft 20 (on-platform or off-platform). Additionally or alternatively, the predictive maintenance system 10 may be utilized to create predictive models for a health management system and/or a health assessment system. The health management system and/or the health assessment system may be configured to monitor, assess, and/or indicate the operational status of one or more active components 34 of the aircraft 20.

The predictive maintenance system 10 utilizes data analytics in the form of machine learning classifiers 66 to identify conditions which may indicate future performance (e.g., impending non-performance event) of the selected active component 34. The predictive maintenance system 10 may discover and communicate meaningful patterns in the flight data and/or extracted feature data that indicate impending non-performance of the selected active component 34. For example, the predictive maintenance system 10 may be applied to a servomechanism of a flight control system 28 to identify non-performance of the servomechanism. When applied, the predictive maintenance system 10 may predict and/or trend a non-performance event of the selected active component 34 (e.g., servomechanism) before it occurs and also may provide a remaining useful life (RUL) estimate of the number of flights before actual non-performance is expected to occur.

As schematically represented in FIG. 5, the predictive maintenance system 10 includes several modules (e.g., instructions and/or data configured to be executed by a computerized system as described with respect to FIG. 7). These modules may be referred to as agents, programs, processes, and/or procedures.

The predictive maintenance system 10 includes a performance classification module 60. The performance classification module 60 may include a primary classification module 64 and an aggregation module 68. The performance classification module 60 is configured to classify extracted feature data, i.e., to utilize features extracted from flight data to form an estimate of the performance status of the selected active component 34 (e.g., the future performance, the likelihood of non-performance, whether non-performance is imminent or not, whether the selected active component 34 is performing as expected or not). The performance classification module 60 is configured to calculate a performance classifier indicator that indicates a performance category of the selected active component within a threshold number of future flights based on the feature data extracted from the flight data.

The performance classification module 60 includes at least one primary classifier 66. Primary classifiers 66, also referred to as models, are machine learning algorithms that identify (i.e., classify) the category (a sub-population) to which a new observation (set of extracted features) belongs. Primary classifiers 66 are chosen and/or configured to transform extracted features into an indication of the primary category (e.g., performance status, a likelihood of non-performance, a likelihood of expected performance, etc.) of the selected active component 34 for a given number of future flights. For example, the indication of the primary category may be an estimate of the likelihood of the selected active component's performance and/or non-performance within a given number of future flights.

The primary classification module 64 is configured to classify extracted feature data in an ensemble of related ways. The primary classification module 64 utilizes features extracted from flight data to form an ensemble of estimates of the status of the selected active component 34. The primary classification module 64 is configured to apply an ensemble of related primary classifiers 66 to the extracted features of the flight data. An ensemble of related primary classifiers 66 also may be referred to as a group and/or a plurality of (related) primary classifiers 66. As used herein, the adjective “primary,” when modifying classification module, classifier, category, classifier indicator, and related elements, indicates a principal, base, fundamental, and/or limited classification related to performance of the selected active component within a given number of future flights.

Primary classifiers 66 of the primary classification module 64 are related in that each relate to the same selected active component 34 and to the same type of primary categories (e.g., same performance status, a likelihood of non-performance, a likelihood of expected performance, etc.), albeit for different time periods as disclosed herein. Thus, the outputs of the (related) primary classifiers 66 (also referred to as the primary classifier indicators) may include a probability metric (e.g., a number representing the likelihood of component non-performance), a “good” state (indicating a likelihood of component performance above a predetermined threshold and/or indicating a likelihood of component non-performance below a predetermined threshold), an “impending non-performance” state (indicating a likelihood of component non-performance above a predetermined threshold and/or indicating a likelihood of component performance below a predetermined threshold), and/or an “abstain” state (indicating the primary classifier 66 did not reliably establish another state and/or metric). The “good” state also may be referred to as the “no impending non-performance” state, the “no impending non-performance event” state, the “no maintenance needed” state, and/or the “low risk” state. The “impending non-performance” state also may be referred to as the “impending non-performance event” state, the “maintenance needed,” and/or the “high risk” state. Primary classifiers 66 may be configured to produce more than one output, for example, producing a weight for a “good” state and a weight for an “impending non-performance” state. Outputs from primary classifiers 66 may be individually normalized (e.g., a probability metric normalized to 1 for 100% probable) and/or normalized in aggregate (e.g., the sum of all outputs is 1).

Primary classifiers 66 may be the result of supervised machine learning and/or guided machine learning in which training data (extracted feature sets which correspond to known outcomes) are analyzed to discern the underlying functional relationship between the extracted features and the outcomes. The underlying function may be an analytical function, a statistical correlation (e.g., a regression), and/or a classification algorithm. Examples of statistical correlations include logistic regression and probit regression. Examples of classification algorithms include naive Bayes classifiers, support vector machines, learned decision trees, ensembles of learned decision trees (e.g., random forests of learned decision trees), and neural networks. Generally, supervised machine learning includes determining the input feature set (the features extracted from the underlying example data), determining the structure of the learned function and corresponding learning algorithm (e.g., support vector machine and/or learned decision trees), applying the learning algorithm to the training data to train the learned function (i.e., the primary classifier 66), and evaluating the accuracy of the learned function (e.g., applying the learned function to a test data set with known outcomes to verify the performance of the learned function).

Each primary classifier 66 is configured to provide a primary category of the active component 34 relating to a given number of future flights (e.g., relating to a predicted performance within the given number of future flights and/or within a given time horizon related to the number of future flights). Primary classifiers 66 of the ensemble of related primary classifiers 66 each provide a primary category (e.g., a likelihood of component non-performance) relating to a different given number of flights (hence, the ensemble also may be referred to as an ensemble of different time horizon classifiers). For example, the ensemble of related primary classifiers 66 may include a first primary classifier 66 that provides a primary category (e.g., the likelihood of component non-performance) relating to the next flight and a second classifier 66 that provides a primary category (e.g., the likelihood of component non-performance) relating to the next two flights. The differing numbers of flights among the primary classifiers 66 may form a series and may form a consecutive sequence of integers beginning at 1. For example, the ensemble of related primary classifiers 66 may estimate the future performance within 1 flight, 2 flights, 3 flights, 4 flights, and 5 flights. Though the example illustrates a sequence of 1 to 5, other maximum numbers in the sequence may be suitable, for example 2, 3, 4, or greater than 5.

The predictive maintenance system 10 includes an aggregation module 68 that is configured to produce an aggregate indicator based on the primary classifier indicators (outputs) of the ensemble of related primary classifiers 66 of the primary classification module 64. The aggregation module 68 is configured to combine the ensemble of primary classifier indicators to form a single performance classifier indicator (also called an aggregate indicator) of the status of the selected active component 34. Though the reliability of the individual primary classifier indicators may be high, by aggregating related primary classifier indicators produced by the primary classification module 64, the aggregation module 68 is configured to produce an aggregate estimate (the performance classifier indicator) of the status of the selected active component 34 that is more reliable than the individual estimates.

The performance classifier indicator indicates the performance category (e.g., the likelihood of component non-performance) relating to a threshold number of future flights. The performance category that is indicated by the aggregation module 68 also may be called the aggregate category. With respect to use of the primary classification module 64 and the aggregation module 68, the threshold number is related to the numbers of flights estimated by the ensemble of related primary classifiers 66 and generally is less than or equal to the maximum number of flights estimated by the ensemble of related primary classifiers. For example, the aggregate indicator may indicate the future performance within 5 flights based on an ensemble of primary classifier indicators that indicate the likelihood of component non-performance within 1 flight, 2 flights, 3 flights, 4 flights, and 5 flights. In some embodiments, the threshold number may be greater than or equal to the maximum number of flights estimated by the ensemble of related primary classifiers.

The aggregation module 68 may be configured to set (i.e., equate) the aggregate indicator to one of a maximum value of the primary classifier indicators, a minimum value of the primary classifier indicators, a median value of the primary classifier indicators, an average value of the primary classifier indicators, a mode of the primary classifier indicators, a most common value of the primary classifier indicators, and a cumulative value of the primary classifier indicators. Where one or more of the primary classifier indicators is a non-Boolean type (e.g., a real value such as a probability metric), the aggregation module 68 may be configured to classify such non-Boolean primary classifier indicators as one of two states (e.g., an impending-non-performance state or a likely-performance state). For example, a likelihood of component non-performance greater than 20% may be classified as an impending-non-performance state, while a likelihood of component non-performance of 20% or less may be classified as a likely-performance state. The threshold of 20% is illustrative only and may be different for different components, different subsystems, and/or different primary classifier indicators.

As an example aggregation approach, the aggregation module 68 may be configured to determine the maximum value of the ensemble of primary classifier indicators, optionally normalizing the values of the primary classifier indicators. This approach may be referred to as the maximum value approach. The aggregate indicator may be set to the maximum (normalized) value of the ensemble of primary classifier indicators and/or may be set to a state (e.g., an impending-non-performance state or a likely-performance state) indicated by the maximum value.

As another example aggregation approach, the aggregation module 68 may be configured to determine the most common primary classifier indicator state among the ensemble of primary classifier indicators. This approach may be referred to as the majority vote approach. If one or more of the primary classifier indicators is a non-Boolean type, the primary classifier indicators may be classified as a particular state, as described herein, prior to determining the most common primary classifier indicator state.

As yet another example aggregation approach, the aggregation module 68 may be configured to determine the cumulative value of the ensemble of primary classifier indicators. This approach may be referred to as the cumulative weight approach. The aggregate indicator may be set to the cumulative value, the average value, or may be set to the state (e.g., the impending-non-performance state or the likely-performance state) indicated by the cumulative value and/or the average value. If the primary classifiers each produce more than one primary classifier indicator, the cumulative value of the corresponding primary classifier indicators may be determined. For example, if each primary classifier produces a weight for a likely-performance state and a weight for an impending-non-performance state, the cumulative weight for the likely-performance state and the cumulative weight for the impending-non-performance state may be determined. The aggregate indicator may be set to the state corresponding to the maximum of the cumulative weights.

Predictive maintenance systems 10 may include a feature extraction module 62 that is configured to extract feature data from flight data collected during a flight of the aircraft. The flight data and the extracted feature data may relate to the performance of the aircraft (e.g., flight performance), the subsystem that includes the selected active component, and/or the selected active component. The flight data may be collected during a single flight or a series of flights. Using flight data from a series of flights may provide a more reliable prediction of component performance because of the greater amount of flight data and/or because the aircraft, the subsystem, and/or the component are more likely to be subjected to a greater range of conditions and/or particular stress conditions.

Examples of flight data include an indication of weight on wheels, sensor status (e.g., operating normally, degraded performance, non-responsive), subsystem settings (e.g., propulsion output, payload presence, etc.), component settings (e.g., flight control surface is deployed), sensor values (e.g., airspeed, acceleration, vertical acceleration, vertical velocity, pitch rate, roll rate, yaw rate, angle of attack, attitude, altitude, heading, position, etc.), control input values (e.g., a control stick position, a control stick lateral position, a control stick longitudinal position, a rudder pedal position, a rudder pedal differential position), engine throttle, a voltage, a current, ambient temperature, and ambient pressure.

Flight data may be collected systematically, e.g., consistently on substantially every flight, consistently in substantially every aircraft, and/or on a consistent basis (e.g., periodically). Flight data relating to different sensors 40 and/or control inputs 42 may be collected at different times or at substantially the same time. Flight data relating to the same sensor 40 or control input 42 generally forms a time series (e.g., periodic, quasi-periodic, or aperiodic).

The feature extraction module 62 may be configured to extract feature data that may be correlated to and/or may indicate likely component performance. The feature extraction module 62 may be configured to determine a statistic of sensor values and/or control input values during a time window, a difference of sensor values and/or control input values during a time window, and/or a difference between sensor values and/or control input values measured at different locations and/or different points in time. Such differences and/or statistics may be referred to as feature data and/or extracted feature data. Feature data generally is derived from sensor values and/or control input values that relate to the same sensed parameter (e.g., a pressure, a temperature, a speed, a voltage, and a current) and/or the same active component 34. The statistic of values may include, and/or may be, a minimum, a maximum, an average, a moving average, a variance, a deviation, a cumulative value, a rate of change, and/or an average rate of change. Additionally or alternatively, the statistic of values may include, and/or may be, a total number of data points, a maximum number of sequential data points, a minimum number of sequential data points, an average number of sequential data points, an aggregate time, a maximum time, a minimum time, and/or an average time that the values are above, below, or about equal to a threshold value. The time window may be the duration of a flight of the aircraft, a portion of the duration of a flight of the aircraft, or a period of time including one or more flights of the aircraft. For example, the time window may be at least 0.1 seconds, at least 1 second, at least 10 seconds, at most 100 seconds, at most 10 seconds, at most 1 second, about 1 second, and/or about 10 seconds.

Additionally or alternatively, the feature extraction module 62 may be configured to analyze and/or extract sensor values and/or control input values within certain constraints. For example, sensor values and/or control input values may be subject to analysis only if within a predetermined range (e.g., outlier data may be excluded) and/or if other sensor values and/or control input values are within a predetermined range (e.g., one sensor value may qualify the acceptance of another sensor value).

The primary classification module 64 may be configured to apply the ensemble of related primary classifiers 66 to the feature data extracted from the flight data from one or more previous flights. Each classifier 66 may be supplied the same feature data or a different subset of the feature data. For example, each primary classifier 66 of an ensemble of two classifiers that estimates the future component performance within 1 flight and 2 flights may be supplied feature data relating to three previous flights. As another example, a primary classifier 66 configured to estimate the future component performance within one flight may be supplied feature data relating to less flights than a primary classifier 66 configured to estimate the likelihood of component non-performance within more than one flight.

Predictive maintenance systems 10 may include a flight data collection module 70 that is configured to collect flight data during one or more flights. Flight data may be collected by the controller(s) 50 and/or the sensor(s) 40 as described herein. The flight data collection module 70 may be configured to collect flight data automatically, e.g., whenever the aircraft is flown.

Predictive maintenance systems 10 may include a display module 72 that is configured to communicate the results of the performance classification module 60, the primary classification module 64, the primary classifiers 66, and/or the aggregation module 68 to the user. For example, the display module 72 may be configured to communicate the primary classifier indicators and/or the aggregate indicator (i.e., the performance classifier indicator). The display module 72 may be configured to communicate system information, such as the identity of the selected active component 34.

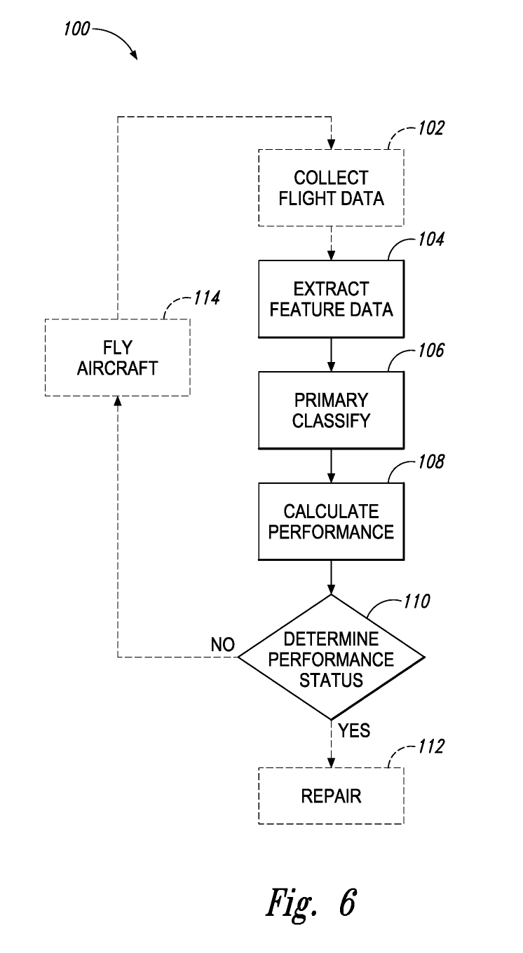

FIG. 6 schematically illustrates predictive maintenance methods 100 for a selected active component (such as active component 34). Methods 100 may be utilized to impact health management of aircraft systems. By reliably predicting future component performance (e.g., a future non-performance event) and thereby enabling a more predictive schedule for repairs and demand for spare parts, methods 100 may contribute to overall aircraft maintenance, fleet management, and material logistics. Methods 100 may include methods of preventative maintenance, methods of determining performance status, and/or methods of determining impending non-performance of components and/or systems.

Methods 100 include calculating 108 performance of the selected active component based on feature data extracted from flight data. Calculating 108 includes calculating the performance classifier indicator that indicates a performance category of the selected active component for a threshold number of future flights of the aircraft (e.g., whether the selected active component is likely to perform or not within the threshold number of future flights).

Methods 100 may include (primary) classifying 106 with an ensemble of related primary classifiers (e.g., primary classifiers 66) to feature data extracted from flight data to produce a primary classifier indicator for each primary classifier of the ensemble of related primary classifiers. Related calculating 108 includes aggregating the primary classifier indicators to produce an aggregate indicator (i.e., the performance classifier indicator) that indicates an aggregate category (i.e., the performance category) of a selected active component of an aircraft for the threshold number of future flights. Methods 100 may include operating and/or utilizing the predictive maintenance system 10. Calculating 108 may include operating and/or utilizing the performance classification module 60. Classifying 106 may include operating and/or utilizing the primary classification module 64. Aggregating may include operating and/or utilizing the aggregation module 68.

Classifying 106 may include applying primary classifiers that each are configured to indicate the primary category (e.g., the likelihood of non-performance) of the selected active component within a given number of future flights of the aircraft. The given numbers of each of the primary classifiers may be different and the group of given numbers may be a series and/or a consecutive sequence of integers beginning with 1. Primary classifiers and ensembles of related primary classifiers may be as described with respect to the predictive maintenance system 10 and/or the primary classification module 64.

Aggregating may include setting (i.e., equating) the performance classifier indicator to one of a maximum value of the primary classifier indicators, a minimum value of the primary classifier indicators, a median value of the primary classifier indicators, an average value of the primary classifier indicators, a mode of the primary classifier indicators, a most common value of the primary classifier indicators, and a cumulative value of the primary classifier indicators, for example as described with respect to the aggregation module 68. Aggregating may include setting the performance classifier indicator following the maximum value approach, the majority vote approach, and/or the cumulative weight approach. The threshold number of future flights may be related to the given numbers of the primary classifiers and may be the maximum of the given numbers of the primary classifiers, as described with respect to the aggregation module 68.

Methods 100 may include extracting 104 feature data from flight data collected during a flight of the aircraft. As described herein, flight data and/or feature data may relate to the performance of the aircraft (e.g., flight performance), a subsystem of the aircraft that includes the selected active component, and/or the selected active component. Extracting 104 may include operating and/or utilizing the feature extraction module 62. Extracting 104 may include determining a statistic of sensor values during a time window, a difference of sensor values during a time window, and/or a difference between sensor values measured at different locations and/or different points in time as described with respect to the feature extraction module 62.

Methods 100 may include collecting 102 flight data during a flight of the aircraft. Collecting 102 may include collecting flight data for a series of flights. Collecting 102 may include operating and/or utilizing the flight data collection module 70, the controller(s) 50, the sensor(s) 40, the control input(s) 42, and/or the aircraft 20 (e.g., if flight data collection module 70 is configured to collect flight data whenever the aircraft is flown). Methods 100 may include flying 114 the aircraft. Flying 114 the aircraft may cause collecting 102. Flying 114 may include routine flying or flying to stress and/or to test the aircraft, the subsystem including the selected active component, and/or the selected active component.

Methods 100 may include displaying the performance classifier indicator (and/or a representation relating to the performance classifier indicator) by visual, audio, and/or tactile display, for example, by utilizing and/or operating the input-output device 216 and/or the display module 72. Additionally or alternatively, methods 100 may include signaling by visual, audio, and/or tactile indicator that the selected active component is likely to perform or to have a non-performance event within the threshold number of future flights. The displaying and/or signaling may include on-board (on platform) and/or off-board (off platform) display and/or signals.

Methods 100 may include determining 110 the performance status of the selected active component based on the performance classifier indicator. Determining 110 may include determining whether the selected active component is likely to perform or not within the threshold number of future flights. Determining 110 may include determining the state of the performance classifier indicator and/or evaluating the value of the performance classifier indicator relative to a predetermined limit (e.g., less than, greater than, and/or about equal to the limit). For example, the need for maintenance may be associated with performance classifier indicators indicating an impending-non-performance state with a likelihood greater than a predetermined limit.

Methods 100 may further include repairing 112 the selected active component. Repairing 112 may include repairing, replacing, refurbishing, mitigating, and/or servicing (e.g., lubricating, cleaning) the selected active component. Methods 100 may include determining whether to repair and/or repairing 112 upon determining 110 the performance status (e.g., determining that a repair would be useful and/or warranted based on the performance classifier indicator). For example, determining whether to repair may include evaluating the value of the performance classifier indicator relative to a predetermined limit (e.g., less than, greater than, and/or about equal to the limit). Where methods 100 include a form of repairing (e.g., repairing 112, repairing 112 upon determining that a repair would be useful, and/or determining whether to repair), methods 100 may be referred to as preventative maintenance methods.

FIG. 7 schematically represents a computerized system 200 that may be used to implement and/or instantiate predictive maintenance systems 10 and associated components, such as controller 50, flight data collection module 70, feature extraction module 62, performance classification module 60, primary classification module 64, aggregation module 68, and/or display module 72. The computerized system 200 includes a processing unit 202 operatively coupled to a computer-readable memory 206 by a communications infrastructure 210. The processing unit 202 may include one or more computer processors 204 and may include a distributed group of computer processors 204. The computerized system 200 also may include a computer-readable storage media assemblage 212 that is operatively coupled to the processing unit 202 and/or the computer-readable memory 206, e.g., by communications infrastructure 210. The computer-readable storage media assemblage 212 may include one or more non-transitory computer-readable storage media 214 and may include a distributed group of non-transitory computer-readable storage media 214.

The communications infrastructure 210 may include a local data bus, a communication interface, and/or a network interface. The communications infrastructure 210 may be configured to transmit and/or to receive signals, such as electrical, electromagnetic, optical, and/or acoustic signals. For example, the communications infrastructure 210 may be configured to manage data link 74.

The computerized system 200 may include one or more input-output devices 216 operatively coupled to the processing unit 202, the computer-readable memory 206, and/or the computer-readable storage media assemblage 212. Input-output devices 216 may be configured for visual, audio, and/or tactile input and/or output. Each input-output device 216 independently may be configured for only input, only output, primarily input, primarily output, and/or a combination of input and output. Examples of input-output devices 216 include monitors (e.g., video monitor), displays (e.g., alphanumeric displays, lamps, and/or LEDs), keyboards, pointing devices (e.g., mice), touch screens, speakers, buzzers, and weights. The display module 72 may include and/or may be an input-output device 216.

The computerized system 200 may include a distributed group of computers, servers, workstations, etc., which each may be interconnected directly or indirectly (including by network connection). Thus, the computerized system 200 may include one or more processing units 202, computer-readable memories 206, computer-readable storage media assemblages 212, and/or input-output devices 216 that are located remotely from one another.

One or both of the computer-readable memory 206 and the computer-readable storage media assemblage 212 include control logic 220 and/or data 222. Control logic 220 (which may also be referred to as software, firmware, and/or hardware) may include instructions that, when executed by the processing unit 202, cause the computerized system 200 to perform one or more of the methods described herein. Control logic 220 may include one or more of the flight data collection module 70, feature extraction module 62, performance classification module 60, primary classification module 64, classifier 66, aggregation module 68, and/or display module 72. Data 222 may include flight data and/or data associated with the modules and/or methods described herein.

Examples of inventive subject matter according to the present disclosure are described in the following enumerated paragraphs.

A1. A method of determining a performance status of a selected active component in an aircraft, the method comprising:

extracting feature data from flight data collected during a flight of the aircraft, wherein the feature data relates to performance of the selected active component, one or more other active components of the aircraft, one or more subsystems of the aircraft, and/or the aircraft;

calculating a performance classifier indicator that indicates a performance category of the selected active component within a threshold number of future flights based on the feature data; and

determining the performance status of the selected active component relative to the threshold number of future flights based on the performance classifier indicator.

A1.1. The method of paragraph A1, wherein the method is a method of determining impending active component non-performance in the aircraft.

A1.2. The method of any of paragraphs A1-A1.1, wherein the method is a method of determining impending subsystem non-performance in the aircraft and wherein the determining the performance status includes determining a performance status of one of the subsystems of the aircraft that includes the selected active component.

A1.3. The method of any of paragraphs A1-A1.2, wherein the selected active component is a selected active component, optionally a flight control surface component, of one of the subsystems of the aircraft, optionally a flight control system.

A1.4. The method of any of paragraphs A1-A1.3, wherein the performance category indicated by the performance classifier indicator is a likelihood of non-performance of the selected active component within the threshold number of future flights.

A1.5. The method of any of paragraphs A1-A1.4, wherein the performance classifier indicator indicates either an impending non-performance event of the selected active component or no impending non-performance event of the selected active component.

A1.6. The method of any of paragraphs A1-A1.5, wherein the performance classifier indicator indicates whether the selected active component is likely to perform unexpectedly within the threshold number of future flights.

A1.7. The method of any of paragraphs A1-A1.6, wherein the performance status relates to whether the selected active component is likely to perform unexpectedly within the threshold number of future flights.

A1.8. The method of any of paragraphs A1-A1.7, wherein the determining the performance status includes determining whether the selected active component is likely to perform unexpectedly within the threshold number of future flights based on the performance classifier indicator.

A1.9. The method of any of paragraphs A1-A1.8, wherein the calculating the performance classifier indicator includes classifying with a performance classifier to produce the performance classifier indicator that indicates the performance category, wherein the performance classifier is configured to indicate the performance category of the selected active component of the aircraft within the threshold number of future flights.

A2. The method of any of paragraphs A1-A1.9, further comprising:

classifying the feature data with an ensemble of related primary classifiers to produce a primary classifier indicator for each primary classifier of the ensemble of related primary classifiers, wherein each primary classifier is configured to indicate a primary category of the selected flight control surface component of the aircraft within a given number of future flights, and wherein the given number for each primary classifier is different;

wherein the calculating the performance classifier indicator includes aggregating the primary classifier indicators to produce the performance classifier indicator that indicates the performance category of the selected active component for the threshold number of future flights, wherein the threshold number is less than or equal to a maximum of the given numbers of the primary classifiers.

A2.1. The method of paragraph A2, wherein the classifying the feature data includes applying the ensemble of related primary classifiers to produce the primary classifier indicator for each primary classifier of the ensemble of related primary classifiers and wherein each primary classifier is configured to identify the primary category to which the feature data belong.

A2.1.1. The method of paragraph A2.1, wherein the applying includes applying the ensemble of related primary classifiers to the feature data to produce the primary classifier indicator for each primary classifier of the ensemble of related primary classifiers.

A2.2. The method of any of paragraphs A2-A2.1.1, wherein the primary category indicated by each primary classifier indicator is a likelihood of non-performance of the selected active component within the given number of future flights of the primary classifier.

A2.3. The method of any of paragraphs A2-A2.2, wherein each primary classifier is configured to classify the feature data as indicating either an impending non-performance event of the selected active component or no impending non-performance event of the selected active component.

A2.4. The method of any of paragraphs A2-A2.3, wherein each primary classifier indicator indicates either an impending non-performance event of the selected active component or no impending non-performance event of the selected active component.

A2.5. The method of any of paragraphs A2-A2.4, wherein each primary classifier is configured to estimate a likelihood of non-performance of the selected active component within the primary classifier's given number of future flights.

A2.6. The method of any of paragraphs A2-A2.5, wherein each primary classifier indicator is an estimate of a likelihood of non-performance of the selected active component within the corresponding primary classifier's given number of future flights.

A2.7. The method of any of paragraphs A2-A2.6, wherein the given numbers of the primary classifiers form a sequence of consecutive integers beginning with 1.

A2.8. The method of any of paragraphs A2-A2.7, wherein the ensemble of related primary classifiers includes a first primary classifier with a given number of 1 and a second primary classifier with a given number of 2.

A2.9. The method of any of paragraphs A2-A2.8, wherein each primary classifier is the result of guided machine learning.

A2.10. The method of any of paragraphs A2-A2.9, wherein at least one, optionally each, primary classifier includes, optionally is, at least one of a naive Bayes classifier, a support vector machine, a learned decision tree, an ensemble of learned decision trees, and a neural network.

A2.11. The method of any of paragraphs A2-A2.10, wherein at least one, optionally each, primary classifier includes at least one of a statistical correlation and a regression.

A2.12. The method of any of paragraphs A2-A2.11, wherein the aggregating includes setting the performance classifier indicator to one of a maximum value of the primary classifier indicators, a minimum value of the primary classifier indicators, a median value of the primary classifier indicators, an average value of the primary classifier indicators, a mode of the primary classifier indicators, a most common value of the primary classifier indicators, and a cumulative value of the primary classifier indicators.

A2.13. The method of any of paragraphs A2-A2.12, wherein the aggregating includes classifying each primary classifier indicator as one of two states, wherein the states include an impending-non-performance state and a likely-performance state, and wherein the aggregating includes setting the performance classifier indicator to a most common state of the primary classifier indicators.

A3. The method of any of paragraphs A1-A2.13, wherein the flight data was collected during a series of flights.

A4. The method of any of paragraphs A1-A3, further comprising collecting the flight data during a flight or series of flights of the aircraft.

A4.1. The method of paragraph A4, wherein the collecting includes collecting the flight data with a sensor on board the aircraft.

A5. The method of any of paragraphs A1-A4.1, wherein the flight data was collected with a sensor on board the aircraft.

A6. The method of any of paragraphs A1-A5, wherein the selected active component is at least one of a flight control surface component, an actuator, a servomechanism, an engine, a motor, an electronics module, and a pump.

A7. The method of any of paragraphs A1-A6, wherein the extracting includes determining a statistic of flight data during a time window, and optionally wherein the flight data includes sensor values and/or control input values.

A7.1. The method of paragraph A7, wherein the statistic includes, optionally is, at least one of a minimum, a maximum, an average, a moving average, a variance, a skewness, a kurtosis, a deviation, a cumulative value, a rate of change, and an average rate of change.

A7.2. The method of any of paragraphs A7-A7.1, wherein the statistic includes, optionally is, a total number of data points, a maximum number of sequential data points, a minimum number of sequential data points, an average number of sequential data points, an aggregate time, a maximum time, a minimum time, and/or an average time that the sensor values are above, below, or about equal to a threshold value.

A7.3. The method of any of paragraphs A7-A7.2, wherein the time window includes, optionally is, a duration of the flight, a portion of a duration of the flight, and/or a period of time including one or more flights of the aircraft, and optionally, when also depending from paragraph A3, wherein the time window includes a duration of each of the series of flights.

A7.4. The method of any of paragraphs A7-A7.3, wherein the time window is at most 10 seconds or at most 1 second.

A7.5. The method of any of paragraphs A7-A7.4, wherein the sensor values include at least one of an airspeed, a temperature, a voltage, a current, an ambient temperature, an ambient pressure, an acceleration, a vertical acceleration, a velocity, a vertical velocity, a pitch rate, a roll rate, a yaw rate, an angle of attack, an attitude, an altitude, a heading, and a component position.

A7.6. The method of any of paragraphs A7-A7.5, wherein the sensor values include a first sensor value relating to the selected active component and a second sensor value relating to another active component of the aircraft.

A7.7. The method of any of paragraphs A7-A7.6, wherein the control input values include at least one of a control stick position, a control stick lateral position, a control stick longitudinal position, a rudder pedal position, a rudder pedal differential position, and an engine throttle setting.

A7.8. The method of any of paragraphs A7-A7.7, wherein the control input values include a first control input value relating to the selected active component and a second control input value relating to another active component of the aircraft.

A8. The method of any of paragraphs A1-A7.8, wherein the extracting includes determining a difference of sensor values and/or control input values during a time window and optionally wherein the flight data includes the sensor values and/or the control input values.

A8.1. The method of paragraph A8, wherein the time window includes, optionally is, a duration of the flight, a portion of a duration of the flight, and/or a period of time including one or more flights of the aircraft, and optionally, when also depending from paragraph A3, wherein the time window includes a duration of each of the series of flights.

A8.2. The method of any of paragraphs A8-A8.1, wherein the time window is at most 10 seconds or at most 1 second.

A8.3. The method of any of paragraphs A8-A8.2, wherein the sensor values include at least one of an airspeed, a temperature, a voltage, a current, an ambient temperature, an ambient pressure, an acceleration, a vertical acceleration, a velocity, a vertical velocity, a pitch rate, a roll rate, a yaw rate, an angle of attack, an attitude, an altitude, a heading, and a component position.

A8.4. The method of any of paragraphs A8-A8.3, wherein the sensor values include a first sensor value relating to the selected active component and a second sensor value relating to another active component of the aircraft.

A8.5. The method of any of paragraphs A8-A8.4, wherein the control input values include at least one of a control stick position, a control stick lateral position, a control stick longitudinal position, a rudder pedal position, a rudder pedal differential position, and an engine throttle setting.

A8.6. The method of any of paragraphs A8-A8.5, wherein the control input values include a first control input value relating to the selected active component and a second control input value relating to another active component of the aircraft.

A9. The method of any of paragraphs A1-A8.6, wherein the extracting includes determining a difference between a first sensor or control input value and a second sensor or control input value, and wherein the flight data includes the first sensor or control input value and the second sensor or control input value.

A9.1. The method of paragraph A9, wherein the first sensor or control input value is either a first sensor value or a first control input value.

A9.2. The method of any of paragraphs A9-A9.1, wherein the second sensor or control input value is either a second sensor value or a second control input value.

A9.3. The method of any of paragraphs A9-A9.2, wherein the first sensor or control input value and the second sensor or control input value relate to a sensed parameter, and optionally wherein the sensed parameter is selected from the group of a rate, a velocity, an acceleration, a position, a pressure, a temperature, a speed, a voltage, and a current.

A9.4. The method of any of paragraphs A9-A9.3, wherein the first sensor or control input value and the second sensor or control input value are measured at different locations.

A9.5. The method of any of paragraphs A9-A9.4, wherein the first sensor or control input value and the second sensor or control input value are measured at different points in time.

A9.6. The method of any of paragraphs A9-A9.5, wherein the first sensor or control input value relates to the selected active component and the second sensor or control input value relates to another active component of the aircraft.

A10. The method of any of paragraphs A1-A9.6, wherein the feature data includes at least one of a minimum of a sensor value, a maximum of a sensor value, an average of a sensor value, a moving average of a sensor value, a variance of a sensor value, a skewness of a sensor value, a kurtosis of a sensor value, a deviation of a sensor value, a cumulative value of a sensor value, a difference of sensor values, a minimum of a control input value, a maximum of a control input value, an average of a control input value, a moving average of a control input value, a variance of a control input value, a skewness of a control input value, a kurtosis of a control input value, a deviation of a control input value, a cumulative value of a control input value, and a difference of control input values.

A11. The method of any of paragraphs A1-A10, further comprising displaying the performance classifier indicator by visual, audio, and/or tactile display.

A12. The method of any of paragraphs A1-A11, further comprising signaling by visual, audio, and/or tactile indicator that the selected active component is likely to have a non-performance event within the threshold number of future flights.

A13. A computerized system comprising:

a computer-readable memory;

a processing unit operatively coupled to the computer-readable memory; and

a computer-readable storage media assemblage, wherein the storage media assemblage is operatively coupled to the computer-readable memory and includes instructions, that when executed by the processing unit, cause the system to perform the method of any of paragraphs A1-A12.

A14. A method of preventive maintenance for an aircraft, the method comprising:

performing the method of any of paragraphs A1-A12; and

determining whether to repair the selected active component before the threshold number of future flights based on the performance status.

A15. The method of paragraph A14, further comprising, upon determining that the performance classifier indicator is less than, greater than, and/or about equal to a limit, repairing the selected active component before the threshold number of future flights.

B1. A system for determining a performance category of a selected active component in an aircraft, the system comprising:

a feature extraction module configured to extract feature data from flight data collected during a flight of the aircraft, wherein the feature data relates to performance of the selected active component, one or more other active components of the aircraft, one or more subsystems of the aircraft, and/or the aircraft;

a performance classification module configured to produce a performance classifier indicator that indicates a performance category of the selected active component of the aircraft within a threshold number of future flights based on the feature data.

B1.1. The system of paragraph B1, wherein the system is a system for determining impending active component non-performance in the aircraft.

B1.2. The system of any of paragraphs B1-B1.1, wherein the system is a system for determining impending subsystem non-performance in the aircraft.

B1.3. The system of any of paragraphs B1-B1.2, wherein the performance category is a likelihood of non-performance of the selected active component within the threshold number of future flights of the performance classifier.

B1.4. The system of any of paragraphs B1-B1.3, wherein the selected active component is a selected active component, optionally a flight control surface component, of one of the subsystems of the aircraft, optionally a flight control system.

B1.5. The system of any of paragraphs B1-B1.4, wherein the performance category indicated by the performance classifier indicator is a likelihood of non-performance of the selected active component within the threshold number of future flights.

B1.6. The system of any of paragraphs B1-B1.5, wherein the performance classifier indicator indicates either an impending non-performance event of the selected active component or no impending non-performance event of the selected active component.

B1.7. The system of any of paragraphs B1-B1.6, wherein the performance classifier indicator indicates whether the selected active component is likely to perform unexpectedly within the threshold number of future flights.

B1.8. The system of any of paragraphs B1-B1.7, wherein the performance category relates to whether the selected active component is likely to perform unexpectedly within the threshold number of future flights.

B2. The system of any of paragraphs B1-B1.8, wherein the performance classification module comprises:

a primary classification module configured to produce a primary classifier indicator for each primary classifier of an ensemble of related primary classifiers, wherein each primary classifier is configured to indicate a primary category of the selected active component of the aircraft within a given number of future flights based on the feature data, and wherein the given number for each primary classifier is different; and

an aggregation module configured to produce the performance classifier indicator that indicates the performance category of the selected active component for the threshold number of future flights based on the primary classifier indicators of the primary classifiers, wherein the threshold number is less than or equal to a maximum of the given numbers of the primary classifiers.

B2.1. The system of paragraph B2, wherein the primary category indicated by each primary classifier indicator is a likelihood of non-performance of the selected active component within the given number of future flights of the primary classifier.

B2.2. The system of any of paragraphs B2-B2.1, wherein each primary classifier is configured to classify the feature data as indicating either an impending non-performance event of the selected active component or no impending non-performance event of the selected active component.

B2.3. The system of any of paragraphs B2-B2.2, wherein each primary classifier indicator indicates either an impending non-performance event of the selected active component or no impending non-performance event of the selected active component.

B2.4. The system of any of paragraphs B2-B2.3, wherein each primary classifier is configured to estimate a likelihood of non-performance of the selected active component within the primary classifier's given number of future flights.

B2.5. The system of any of paragraphs B2-B2.4, wherein each primary classifier indicator is an estimate of a likelihood of non-performance of the selected active component within the corresponding primary classifier's given number of future flights.

B2.6. The system of any of paragraphs B2-B2.5, wherein the given numbers of the primary classifiers form a sequence of consecutive integers beginning with 1.

B2.7. The system of any of paragraphs B2-B2.6, wherein the ensemble of related primary classifiers includes a first primary classifier with a given number of 1 and a second primary classifier with a give number of 2.

B2.8. The system of any of paragraphs B2-B2.7, wherein each primary classifier is the result of guided machine learning.

B2.9. The system of any of paragraphs B2-B2.8, wherein at least one, optionally each, primary classifier includes, optionally is, at least one of a naive Bayes classifier, a support vector machine, a learned decision tree, an ensemble of learned decision trees, and a neural network.

B2.10. The system of any of paragraphs B2-B2.9, wherein at least one, optionally each, classifier includes at least one of a statistical correlation and a regression.

B2.11. The system of any of paragraphs B2-B2.10, wherein the aggregation module is configured to set the performance classifier indicator to one of a maximum value of the primary classifier indicators, a minimum value of the primary classifier indicators, a median value of the primary classifier indicators, an average value of the primary classifier indicators, a mode of the primary classifier indicators, a most common value of the primary classifier indicators, and a cumulative value of the primary classifier indicators.

B2.12. The system of any of paragraphs B2-B2.11, wherein the aggregation module is configured to classify each primary classifier indicator as one of two states, wherein the states include an impending-non-performance state and a likely-performance state, and wherein the aggregation module is configured to set the performance classifier indicator to a most common state of the primary classifier indicators.

B3. The system of any of paragraphs B1-B2.12, further comprising a data link configured to communicate with a flight data storage system, and optionally wherein the flight data storage system is on board the aircraft.

B4. The system of any of paragraphs B1-B3, further comprising a display, wherein the display is configured to indicate the performance classifier indicator with a visual, audio, and/or tactile display.

B5. The system of any of paragraphs B1-B4, further comprising a sensor on board the aircraft, wherein the sensor is configured to collect flight data during the flight of the aircraft.

B6. The system of any of paragraphs B1-B5, wherein the selected active component includes, optionally is, at least one of a flight control surface component, an actuator, a servomechanism, an engine, a motor, an electronics module, and a pump.

B7. The system of any of paragraphs B1-B6, wherein the feature extraction module is configured to determine a statistic of flight data during a time window, and optionally wherein the flight data includes sensor values and/or control input values.

B7.1. The system of paragraph B7, wherein the statistic includes, optionally is, at least one of a minimum, a maximum, an average, a moving average, a variance, a skewness, a kurtosis, a deviation, a cumulative value, a rate of change, and an average rate of change.

B7.2. The system of any of paragraphs B7-B7.1, wherein the statistic includes, optionally is, at least one of a total number of data points, a maximum number of sequential data points, a minimum number of sequential data points, an average number of sequential data points, an aggregate time, a maximum time, a minimum time, and an average time that the sensor values are above, below, or about equal to a threshold value.

B7.3. The system of any of paragraphs B7-B7.2, wherein the time window includes, optionally is, a duration of the flight, a portion of a duration of the flight, and/or a period of time including one or more flights of the aircraft.

B7.4. The system of any of paragraphs B7-B7.3, wherein the time window is at most 10 seconds or at most 1 second.

B7.5. The system of any of paragraphs B7-B7.4, wherein the sensor values include at least one of an airspeed, a temperature, a voltage, a current, an ambient temperature, an ambient pressure, an acceleration, a vertical acceleration, a velocity, a vertical velocity, a pitch rate, a roll rate, a yaw rate, an angle of attack, an attitude, an altitude, a heading, and a component position.

B7.6. The system of any of paragraphs B7-B7.5, wherein the sensor values include a first sensor value relating to the selected active component and a second sensor value relating to another active component of the aircraft.

B7.7. The system of any of paragraphs B7-B7.6, wherein the control input values include at least one of a control stick position, a control stick lateral position, a control stick longitudinal position, a rudder pedal position, a rudder pedal differential position, and an engine throttle setting.

B7.8. The system of any of paragraphs B7-B7.7, wherein the control input values include a first control input value relating to the selected active component and a second control input value relating to another active component of the aircraft.

B8. The system of any of paragraphs B1-B7.8, wherein the feature extraction module is configured to determine a difference of sensor values and/or control input values during a time window and optionally wherein the flight data includes the sensor values and/or the control input values.

B8.1. The system of paragraph B8, wherein the time window includes, optionally is, a duration of the flight, a portion of a duration of the flight, and/or a period of time including one or more flights of the aircraft.

B8.2. The system of any of paragraphs B8-B8.1, wherein the time window is at most 10 seconds or at most 1 second.

B8.3. The system of any of paragraphs B8-B8.2, wherein the sensor values include at least one of an airspeed, a temperature, a voltage, a current, an ambient temperature, an ambient pressure, an acceleration, a vertical acceleration, a velocity, a vertical velocity, a pitch rate, a roll rate, a yaw rate, an angle of attack, an attitude, an altitude, a heading, and a component position.

B8.4. The system of any of paragraphs B8-B8.3, wherein the sensor values include a first sensor value relating to the selected active component and a second sensor value relating to another active component of the aircraft.

B8.5. The system of any of paragraphs B8-B8.4, wherein the control input values include at least one of a control stick position, a control stick lateral position, a control stick longitudinal position, a rudder pedal position, a rudder pedal differential position, and an engine throttle setting.

B8.6. The system of any of paragraphs B8-B8.5, wherein the control input values include a first control input value relating to the selected active component and a second control input value relating to another active component of the aircraft.

B9. The system of any of paragraphs B1-B8.6, wherein the feature extraction module is configured to determine a difference between a first sensor or control input value and a second sensor or control input value, and wherein the flight data includes the first sensor or control input value and the second sensor or control input value.

B9.1. The system of paragraph B9, wherein the first sensor or control input value is either a first sensor value or a first control input value.

B9.2. The system of any of paragraphs B9-B9.1, wherein the second sensor or control input value is either a second sensor value or a second control input value.

B9.3. The system of any of paragraphs B9-B9.2, wherein the first sensor or control input value and the second sensor or control input value relate to a sensed parameter, and optionally wherein the sensed parameter is selected from the group of a rate, a velocity, an acceleration, a position, a pressure, a temperature, a speed, a voltage, and a current.

B9.4. The system of any of paragraphs B9-B9.3, wherein the first sensor or control input value and the second sensor or control input value are measured at different locations.

B9.5. The system of any of paragraphs B9-B9.4, wherein the first sensor or control input value and the second sensor or control input value are measured at different points in time.

B9.6. The system of any of paragraphs B9-B9.5, wherein the first sensor or control input value relates to the selected active component and the second sensor or control input value relates to another active component of the aircraft.

B10. The system of any of paragraphs B1-B9.6, further comprising:

a computer-readable memory;

a processing unit operatively coupled to the computer-readable memory; and

a computer-readable storage media assemblage, wherein the storage media assemblage is operatively coupled to the computer-readable memory and includes the feature extraction module and the performance classification module.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, the phrases “at least one of” and “one or more of,” in reference to a list of more than one entity, means any one or more of the entities in the list of entities, and is not limited to at least one of each and every entity specifically listed within the list of entities. For example, “at least one of A and B” (or, equivalently, “at least one of A or B,” or, equivalently, “at least one of A and/or B”) may refer to A alone, B alone, or the combination of A and B.

As used herein, the singular forms “a”, “an” and “the” may be intended to include the plural forms as well, unless the context clearly indicates otherwise.

The various disclosed elements of systems and steps of methods disclosed herein are not required of all systems, apparatuses, and methods according to the present disclosure, and the present disclosure includes all novel and non-obvious combinations and subcombinations of the various elements and steps disclosed herein. Moreover, any of the various elements and steps, or any combination of the various elements and/or steps, disclosed herein may define independent inventive subject matter that is separate and apart from the whole of a disclosed system, apparatus, or method. Accordingly, such inventive subject matter is not required to be associated with the specific systems, apparatuses, and methods that are expressly disclosed herein, and such inventive subject matter may find utility in systems, apparatuses, and/or methods that are not expressly disclosed herein.

1. A method of determining a performance status of a selected flight control surface component in an aircraft, the method comprising:
extracting feature data from flight data collected during a flight of the aircraft, wherein the feature data relates to flight performance of the aircraft and performance of the selected flight control surface component;
calculating a performance classifier indicator that indicates a performance category of the selected flight control surface component within a threshold number of future flights based on the feature data; and
determining the performance status of the selected flight control surface component relative to the threshold number of future flights based on the performance classifier indicator.

2. The method of claim 1, further comprising:
classifying the feature data with an ensemble of related primary classifiers to produce a primary classifier indicator for each primary classifier of the ensemble of related primary classifiers, wherein each primary classifier is configured to indicate a primary category of the selected flight control surface component of the aircraft within a given number of future flights, and wherein the given number for each primary classifier is different;
wherein the calculating the performance classifier indicator includes aggregating the primary classifier indicators to produce the performance classifier indicator that indicates the performance category of the selected flight control surface component for the threshold number of future flights, wherein the threshold number is less than or equal to a maximum of the given numbers of the primary classifiers.

3. The method of claim 2, wherein the given numbers of the primary classifiers form a sequence of consecutive integers beginning with 1.

4. The method of claim 2, wherein the aggregating includes setting the performance classifier indicator to one of a maximum value of the primary classifier indicators, a most common value of the primary classifier indicators, and a cumulative value of the primary classifier indicators.

5. The method of claim 2, wherein the aggregating includes classifying each primary classifier indicator as one of two states, wherein the states include an impending-non-performance state and a likely-performance state, and wherein the aggregating includes setting the performance classifier indicator to a most common state of the primary classifier indicators.

6. The method of claim 1, wherein the flight data includes control input values, wherein the extracting includes determining a statistic of the control input values during a time window, and wherein the control input values include at least one of a control stick position, a control stick lateral position, a control stick longitudinal position, a rudder pedal position, a rudder pedal differential position, and an engine throttle setting.

7. The method of claim 1, wherein the extracting includes determining a difference of sensor values during a time window and wherein the flight data includes the sensor values.

8. The method of claim 7, wherein the sensor values include a first sensor value relating to the selected flight control surface component and a second sensor value relating to another active component of the aircraft.

9. The method of claim 1, wherein the performance classifier indicator indicates either an impending non-performance event of the selected flight control surface component or no impending non-performance event of the selected flight control surface component.

10. A method of preventive maintenance for an aircraft, the method including:
performing the method of claim 1; and
determining whether to repair the selected flight control surface component before the threshold number of future flights based on the performance status.

11. A system for determining a performance category of a selected flight control surface component in an aircraft, the system comprising:
a feature extraction module configured to extract feature data from flight data collected during a flight of the aircraft, wherein the feature data relates to flight performance of the aircraft and performance of the selected flight control surface component; and
a performance classification module configured to produce a performance classifier indicator that indicates a performance category of the selected flight control surface component within a threshold number of future flights based on the feature data.

12. The system of claim 11, wherein the performance classification module comprises:
a primary classification module configured to produce a primary classifier indicator for each primary classifier of an ensemble of related primary classifiers, wherein each primary classifier is configured to indicate a primary category of the selected flight control surface component of the aircraft within a given number of future flights based on the feature data, and wherein the given number for each primary classifier is different; and
an aggregation module configured to produce the performance classifier indicator that indicates the performance category of the selected flight control surface component for the threshold number of future flights based on the primary classifier indicators of the primary classifiers, wherein the threshold number is less than or equal to a maximum of the given numbers of the primary classifiers.

13. The system of claim 12, wherein the ensemble of related primary classifiers includes a first primary classifier with a given number of 1 and a second primary classifier with a given number of 2.

14. The system of claim 12, wherein the aggregation module is configured to set the performance classifier indicator to one of a maximum value of the primary classifier indicators, a most common value of the primary classifier indicators, and a cumulative value of the primary classifier indicators.

15. The system of claim 12, wherein the aggregation module is configured to classify each primary classifier indicator as one of two states, wherein the states include an impending-non-performance state and a likely-performance state, and wherein the aggregation module is configured to set the performance classifier indicator to a most common state of the primary classifier indicators.

16. The system of claim 11, further comprising a data link configured to communicate with a flight data storage system, and wherein the flight data storage system is on board the aircraft.

17. The system of claim 11, further comprising a display, wherein the display is configured to indicate the performance classifier indicator with at least one of a visual display, an audio display, and a tactile display.

18. The system of claim 11, wherein the flight data includes control input values, wherein the feature extraction module is configured to determine a statistic of the control input values during a time window, and wherein the control input values include at least one of a control stick position, a control stick lateral position, a control stick longitudinal position, a rudder pedal position, a rudder pedal differential position, and an engine throttle setting.

19. The system of claim 11, wherein the feature extraction module is configured to determine a difference of sensor values during a time window, wherein the flight data includes the sensor values, and wherein the sensor values include at least one of a velocity, a vertical velocity, a pitch rate, a roll rate, a yaw rate, an angle of attack, an attitude, and a component position.

20. The system of claim 11, wherein the feature extraction module is configured to determine a difference between a first sensor value and a second sensor value, wherein the flight data includes the first sensor value and the second sensor value, and wherein the first sensor value relates to the selected flight control surface component and the second sensor value relates to another active component of the aircraft.
